(19) United States
(12) Patent Application Publication
(10) Pub. No.: US 2020/0280539 A1
(43) Pub. Date: Sep. 3, 2020

(54) REAL-TIME THIRD-PARTY AUTHORIZATION OF COMMUNICATION SESSIONS

(71) Applicant: Andrew Navamoni Jebasingh, Cedar Park, TX (US)

(72) Inventor: Andrew Navamoni Jebasingh, Cedar Park, TX (US)

(21) Appl. No.: 16/410,173

(22) Filed: May 13, 2019

Related U.S. Application Data
(60) Provisional application No. 62/812,024, filed on Feb. 28, 2019.

(51) Int. Cl. H04L 29/06; H04L 29/08; H04L 12/58

(52) U.S. Cl. CPC H04L 63/0263; H04L 51/32; H04L 63/0254; H04L 67/141

(57) ABSTRACT

Systems, methods, and computer program products for managing communication between communication devices. In response to receiving a request to initiate a communication session between communication devices including at least one managed device, a communication database is queried for a rule governing the communication session. The communication request is then processed in accordance with the rule. The rule may require forwarding the request to an administrator device, forwarding the request to the communication device to which the communication session is directed, or denying the request. In cases where the communication request is forwarded to the administrator device, an administrator may provide input to the device indicating whether the communication session is authorized. If authorization is provided, the communication database may be updated to allow subsequent communication sessions. If authorization is denied, the communication database may be updated to deny subsequent communication sessions.

### CROSS-REFERENCE TO RELATED APPLICATIONS

This application claims the benefit of U.S. Application No. 62/812,024 filed on Feb. 28, 2019, and entitled “A Method To Let A 3^{rd} Party Authorize Calls And Texts To And From The First Party”, the disclosure of which is incorporated by reference herein in its entirety.

### BACKGROUND

This invention generally relates to personal communication technology and, in particular, to systems, methods, and computer program products for controlling communication between devices.

At one time, parents, caregivers, or other guardians could keep track of who their dependents were speaking to on a regular basis by screening calls to their home. This paradigm changed as mobile phones became ubiquitous. Now, unscrupulous callers can reach children and other venerable persons directly on their personal mobile phones using computerized auto-dialers. The internet connectivity provided by smartphones also allows dependents to communicate with nefarious persons using voice over IP, text messages, or social media applications, and to visit inappropriate websites without the knowledge of their guardians.

Because mobile phones are often considered a necessity, restricting access dependents have to their phone is typically not a reasonable option for controlling communication. Thus, guardians cannot easily manage who can directly communicate with their dependents. Guardians can attempt to block calls by asking the carrier to create a limited blacklist, or by creating a limited whitelist using features on the dependent's phone. However, these methods are slow, require manual intervention that is often nonintuitive and subject to cooperation by the carrier or dependent user, and are ultimately ineffective against many types of undesirable callers. These methods also require prior knowledge of the numbers that need to be added to the blacklist or whitelist, and often do not work with the devices preferred by the dependents.

Thus, there is a need for improved systems, methods, and computer program products which enable guardians to control who can and cannot communicate with their dependents.

### SUMMARY

In an embodiment of the invention, a system is provided. The system includes one or more processors and a memory coupled to the one or more processors that includes program code. When executed by at least one of the one or more processors, the program code causes the system to receive a request to initiate a communication session between a first communication device and a second communication device, query a communication database for a rule governing the communication session between the first communication device and the second communication device, and process the request in accordance with the rule, wherein the rule requires one of forwarding the request to an administrator device, forwarding the request to the one of the first communication device or the second communication device, or denying the request.

In another embodiment of the invention, a method is provided. The method includes receiving the request to initiate the communication session between the first communication device and the second communication device, querying the communication database for the rule governing the communication session between the first communication device and the second communication device, and processing the request in accordance with the rule, wherein the rule requires one of forwarding the request to the administrator device, forwarding the request to the one of the first communication device or the second communication device, or denying the request.

In another embodiment of the invention, a computer program product is provided. The computer program product includes a non-transitory computer-readable storage medium, and program code stored on the non-transitory computer-readable storage medium. The program code is configured so that, when executed by one or more processors, the program code causes the one or more processors to receive the request to initiate the communication session between the first communication device and the second communication device, query the communication database for the rule governing the communication session between the first communication device and the second communication device, and process the request in accordance with the rule, wherein the rule requires one of forwarding the request to the administrator device, forwarding the request to the one of the first communication device or the second communication device, or denying the request.

The above summary presents a simplified overview of some embodiments of the invention to provide a basic understanding of certain aspects of the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment that includes a mobile network in communication with a plurality of communication devices and a communication management system.

FIGS. 2-9 are diagrammatic views of messaging between the mobile network, communication devices, and communication management system of FIG. 1 under various operational scenarios.

FIG. 10 is a diagrammatic view of a computer that may be used to implement one or more of the components or processes shown in FIGS. 1-9.

### DETAILED DESCRIPTION

Embodiments of the invention allow guardians or other responsible parties to authorize or deny communication through managed communication devices (e.g., mobile phones of dependents) in real time. To this end, a communication management system manages requests for communication session (e.g., a voice call, video call, text message, social media message, access to a web site, etc.) from and to each managed device, and contacts a designated administrator (e.g., a parent, caregiver, or other guardian) for approval before allowing communication sessions when unauthorized communication is detected. The communication management system may allow on demand control of communication without the administrator having to pre-enter a list of authorized numbers. For example, when a new number tries to call a managed communication device, an alert may be sent to a designated communication device of the administrator requesting authorization. Using this mechanism, a whitelist may be built and managed over time.

Embodiments of the invention may also be used to block social media messages or posts as well as unauthorized calls made using external messaging systems, such as WhatsApp, which is a cross-platform messaging and Voice over IP service available from Facebook, Inc. of Menlo Park, Calif. Attempted access to a Uniform Resource Locator (URL) may also trigger a request for authorization from the communication management system. The communication management system may thereby control access to the Internet by managed devices.

The administrator may designate one or more phone numbers that act as authorization contacts for the communication devices they manage. When an unknown call or other communication request is sent to a managed device, an authorization request may be transmitted to one or more administrator devices, e.g. via a Short-Message-Service (SMS) or any other suitable communication protocol. In response to receiving the message, the administrator may have the option of transmitting an authorization response that either authorizes or prohibits the requested communication session. If the administrator authorizes the communication session, the next time that party calls, the call may be allowed to go through to the managed device without first contacting the administrator. Multiple administrator devices may be designated so that if one administrator device fails to respond, the authorization request can be forwarded to another administrator device.

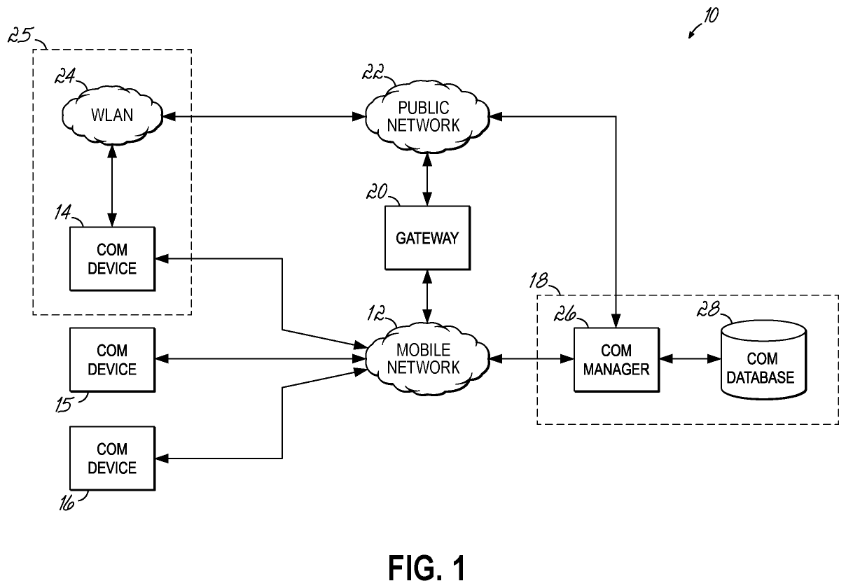

FIG. 1 depicts an operational environment 10 in accordance with an embodiment of the invention that includes a mobile network 12 in communication with a plurality of communication devices 14-16, a communication management system 18, and a gateway 20. The gateway 20 may operatively couple the mobile network 12 to one or more additional networks, such as public network 22. The mobile network 12 may be a cellular network comprising a plurality of base transceiver stations that provide wireless coverage over a wide geographic area and which are connected by one or more mobile switching centers. The gateway 20 may be configured to allow the mobile network 12 to communicate with communication devices 14-16 using other networks, such a wireless local access network (WLAN) 24. The public network 22 may include, for example, one or more of the Internet, a local area network (LAN), a wide area network (WAN), another mobile network, or any other suitable communication network.

The communication devices 14-16 may be mobile phones or other hand-held computing devices that communicate through the mobile network 12 using voice or data services, as well as various other networks, such as WLAN 24. The WLAN 24 may represent a local network through which communication devices 14-16 can access the public network 22 using a wireless communication protocol (e.g., Wi-Fi), and may provide coverage in a privately-owned location 25, such as the home of the user of communication device 14.

The communication management system 18 may include a communication manager 26 in communication with the mobile and public networks 12, 22, and a communication database 28. The communication manager 26 may be a running instance of one or more applications that provide the features of one or more embodiments of the invention. For example, the communication manager 26 may include a database management system that manages a communication database 28, and may also include a web-server application that enables users to access the communication database 28 through the public network 22. The communication management system 18 may be an external system in communication with the mobile network 12 and communication devices 14-16, or may be integrated into the mobile network 12. Thus, one or more of features of the communication management system 18 may be provided at a carrier level by nodes within the mobile network 12. One or more features of the communication management system 18 may also be provided at a communication device level using one or more applications resident on one or more of the communication devices 14-16, or by the operating system of the communication devices 14-16.

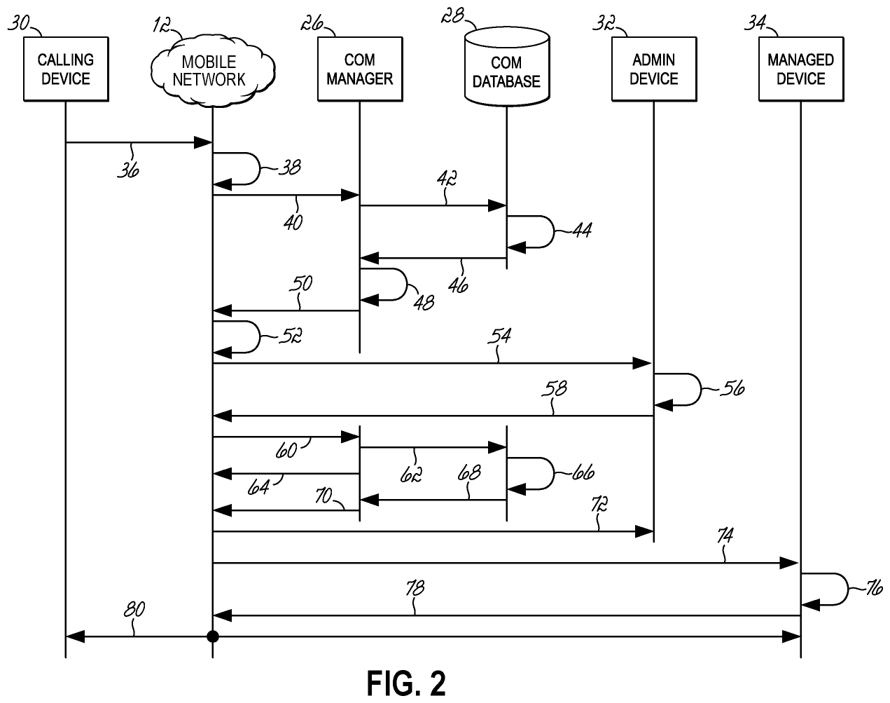

FIGS. 2-9 illustrate exemplary messaging that may occur between the mobile network 12, communication manager 26, communication database 28, a calling device 30, an administrator device 32, and a managed device 34 to manage a communication session. By way of example, the administrator device 32 may be a communication device used by a guardian or other administrator, and the managed device 34 may be a communication device used by a dependent.

FIG. 2 depicts an exemplary scenario in which a previously unknown calling device 30 attempts to initiate a communication session with the managed device 34, and the communication session is authorized by the administrator. To initiate the communication session, the calling device 30 may transmit a session request message 36 (e.g., a call setup message) to the mobile network 12. The session request message 36 may include information that identifies the calling device 30 (e.g., an international mobile subscriber identity (IMSI), mobile subscription identification number (MSIN) or other phone number of the calling device 30), that identifies the managed device 34 (e.g., an IMSI or MSIN of the managed device 34) and the type of communication session being requested, (e.g., a call, text message, video chat, social media communication, etc.).

In response to receiving the session request message 36, the mobile network 12 may process the request 38. Request processing may include querying a subscriber database, such as a home location register (HLR) of the mobile network 12, to determine a network location for, and any features associated with, the managed device 34. The subscriber database query may return subscriber data relating to the managed device 34, such as a mobile station roaming number (MSRN), network routing information, and features to which the managed device 34 is subscribed. Based on the subscriber data, the mobile network 12 may determine that the managed device 34 is subscribed to a feature associated with the communication manager 26.

In response to determining that communication with the managed device 34 is managed by the communication manager 26, the mobile network 12 may transmit a session request message 40 to the communication manager 26. The session request message 40 may include information relating to the session request message 36 received from the calling device 30 (e.g., caller identification data (CID), automatic number identification (ANI) data, etc.), or may be a forwarded version of the session request message 36. In response to receiving the session request message 40, the communication manager 26 may transmit a database query message 42 to the communication database 28 requesting information relating to how the session request message 40 should be processed.

In response to receiving the database query message 42, the communication database 28 may perform a database search 44 to determine if the calling device 30 is associated with the managed device 34, and if so, what rules apply to the calling device 30 with respect to communication with the managed device 34. For example, the communication database 28 may determine if the calling device 30 is pre-authorized to communicate with the managed device 34, an if so, what types of communication are pre-authorized and when these communication sessions can occur. If the calling device 30 is not recognized by the communication database 28, the communication database 28 may determine what session processing rules apply to unknown calling devices. Session processing rules for unknown calling devices may include, for example, requesting authorization from the administrator device 32.

In an embodiment of the invention, the database search 44 results may indicate that the calling device 30 is associated with a known malicious caller. This determination may be made, for example, based on previously processed calls to other managed devices. In the case of a known malicious caller, the session processing rules may indicate that the session request message 36 should be denied even though the calling device 30 has not previously attempted to call the managed device 34. Rules that block or allow communications during certain times of the day or week, or that limit the number of minutes or messages sent between the calling device 30 and managed device 34 may also be implemented by the communication management system 18.

Based on the results of the database search 44, the communication database 28 may transmit a reply message 46 to the communication manager 26 including instructions or other data for processing the session request message 40. The communication manager 26 may process the session request 48 using data received in the reply message 46. If the calling device 30 was not recognized by the communication database 28, the communication manager 26 may determine that the session request must be authorized by the administrator device 32 before the requested communication session can be established. The communication manager 26 may then transmit an authorization request message 50 (e.g., in the form of a text message) to the mobile network 12 for delivery to the administrator device 32.

In an alternative embodiment of the invention, in response to determining that the session request must be authorized by the administrator device 32, the communication manager 26 may transmit a session setup message (not shown) to the mobile network 12 that causes the calling device 30 to be connected to a voicemail or other messaging system associated with the administrator device 32. The caller may then leave a message which can be received by the administrator at their convenience. The administrator may then determine whether to authorize future communication sessions between the calling device 30 and managed device 34. In response to the administrator authorizing or denying communication, the communication management system 18 may send a message to the calling device 30 informing the user that they have been granted or denied permission to communicate with the managed device 34.

In another alternative embodiment of the invention, the communication manager 26 may play or send a message to the calling device 30 notifying the user that the requested communication session must be authorized before it can be completed. In this case, the calling device 30 may be disconnected or placed on hold while authentication is performed. If the communication session is ultimately authorized, the communication manager 26 may then notify the caller that the communication session has been authorized. This notification may be in the form of an automated call, text message, social media message, or any other suitable notification.

The mobile network 12 may process the authorization request 52 and forward the authorization request message 54 to the administrator device 32, e.g., using SMS or some other suitable communication protocol. The administrator device 32 may process the authorization request 56, e.g., using a mobile application running on the administrator device 32. Processing the authorization request 56 may include extracting data from the authorization request message 54 (e.g., CID or calling name), displaying information on a user interface of the administrator device 32 prompting the user to approve or deny the communication session, and receiving input from the user indicative of their choice.

In an alternative embodiment of the invention, processing the authorization request 52 may include transmitting a response (not shown) to the calling device 30 requesting the calling device 30 confirm the session request message 36, e.g., by providing a voice command or activating a button on a user interface of the calling device 30. The mobile network 12 or communication manager 26 may then only forward the respective authorization request message 50, 54 to the administrator device 32 if the confirmation is received from the calling device 30. This feature may prevent administrators from being disturbed by calls from automated dialers, for example.

In another alternative embodiment of the invention, processing the authorization request 52 may include transmitting a response (not shown) to the calling device 30 informing the user of the calling device 30 that the calling device 30 is not recognized, and asking the user to confirm that they want to request authorization. The mobile network 12 or communication manager 26 may then only forward the respective authorization request message 50, 54 to the administrator device 32 if the user requests or otherwise agrees to being authorized. The response transmitted to the calling device 30 may also notify the user that completion of their call could take a moment while authorization is performed.

In response to receiving user input indicating the communication session is authorized, the administrator device 32 may transmit a reply message 58 to the mobile network 12, e.g., in the form of another text message. The mobile network 12 may in turn forward the reply message 60 to the communication manager 26. Based on the content of the reply message 60, the communication manager 26 may transmit a database update message 62 to the communication database 28 and a session response message 64 to the mobile network 12.

In response to receiving the database update message 62, the communication database 28 may update the database 66, e.g., by adding the calling device 30 to a whitelist if authorization to communicate with the managed device 34 has been granted to the calling device 30. In other cases, the calling device 30 may be added to a blacklist, e.g., if authorization to communicate with the managed device 34 has been denied. The administrator may also authorize or deny the requested communication session on a one-time basis, in which case the communication database 28 may merely log the communication session request without adding the calling device 30 to either a whitelist or a blacklist.

In response to successfully updating the database 66, the communication database 28 may transmit an acknowledgement message 68 to the communication manager 26 indicating that the database has been updated. The communication manager 26 may then forward the acknowledgment message 70 to the mobile network 12, which in turn may forward the acknowledgement message 72 to the administrator device 32. The administrator device 32 may provide an indication to the administrator that the status of the calling device 30 has been updated in the communication database 28. The administrator device 32 may also store data associated with the calling device 30. This data may be used, for example, to facilitate later editing of the authorization status of calling device 30 in communication database 28.

In response to receiving the session response message 64 indicating the requested communication session has been authorized, the mobile network 12 may establish or otherwise allow the communication session between the calling device 30 and managed device 34. This may include the mobile network 12 forwarding a session request message 74 to the managed device 34. In response to receiving the session request message 74, the user of the managed device 34 may accept the request 76, e.g., by answering a call or video chat request. The managed device 34 may then transmit an acknowledgement message 78 to the mobile network 12, which may in turn establish the communication session 80 between the calling device 30 and managed device 34. If the requested communication session merely involves one-way transmission from the calling device 30 to the managed device 34 (e.g., a text message), the session request message 74 may comprise a message that is delivered to the managed device 34, and the user may not need to actively accept the request 76 to establish or complete the communication session.

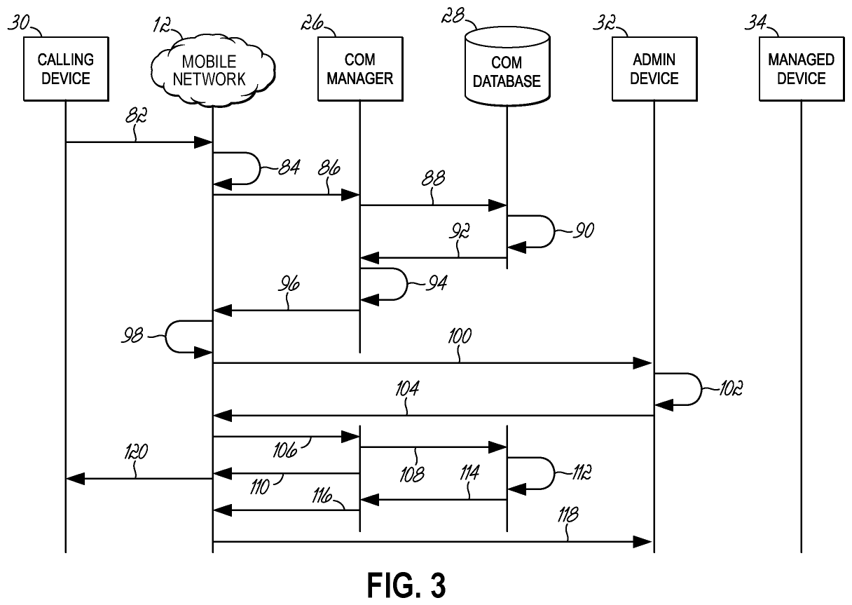

FIG. 3 depicts an exemplary scenario in which the previously unknown calling device 30 attempts to initiate a communication session with the managed device 34, and the communication session is denied by the administrator. As described above with respect to FIG. 2, the calling device 30 may transmit the session request message 82 to the mobile network 12. In response, the mobile network 12 may process the request 84 and determine that the managed device 34 is subscribed to the communication management feature associated with the communication manager 26. In response to this determinization, the mobile network 12 may transmit a session request message 86 to the communication manager 26. In response to receiving the session request message 86, the communication manager 26 may transmit a database query message 88 to the communication database 28 requesting information relating to how the session request message 86 should be processed.

In response to receiving the database query message 88, the communication database 28 may perform a database search 90 and, because the calling device 30 is unknown, return session processing rules that require authorization from the administrator device 32. The communication database 28 may transmit a reply message 92 to the communication manager 26. The communication manager 26 may process the session request 94 using the data received in the reply message 92, and determine that the session request message 86 must be authorized by the administrator device 32 before the requested communication session can be established. The communication manager 26 may then transmit an authorization request message 96 to the mobile network 12 for delivery to the administrator device 32.

The mobile network 12 may process the authorization request 98 and forward the authorization request message 100 to the administrator device 32. The administrator device 32 may process the authorization request 102, and in response to receiving user input indicating the communication session is not authorized, transmit a reply message 104 to the mobile network 12. The mobile network 12 may in turn forward the reply message 106 to the communication manager 26. In response to receiving the reply message 106, the communication manager 26 may transmit a database update message 108 to the communication database 28, and a session response message 110 to the mobile network 12 indicating the communication session should be denied.

In response to receiving the database update message 108, the communication database 28 may update the database 112, e.g., by adding the calling device 30 to a blacklist, and transmit an acknowledgement message 114 to the communication manager 26 indicating the database has been updated. The communication manager 26 may then forward the acknowledgment message 116 to the mobile network 12, which in turn may forward the acknowledgement message 118 to the administrator device 32, thereby confirming the status of the calling device 30 has been updated in the communication database 28. In response to receiving the session response message 110 indicating the requested communication session has been denied, the mobile network 12 may terminate the communication session 120. As a result, the user of the managed device 34 may remain unaware that the user of calling device 30 was attempting to contact them.

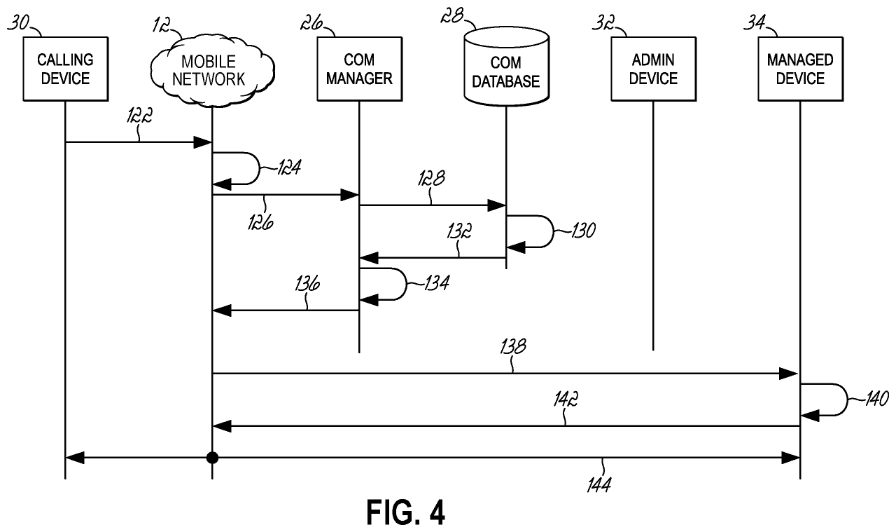

FIG. 4 depicts an exemplary scenario in which the calling device 30 attempts to initiate a communication session with the managed device 34 subsequent to having been authorized to communicate with the managed device 34, such as described above with respect to FIG. 2. The communication session may begin with the calling device 30 transmitting a session request message 122 to the mobile network 12, the mobile network 12 processing the request 124 and transmitting a session request message 126 to the communication manager 26, and the communication manager 26 transmitting a database query message 128 to the communication database 28.

In response to receiving the database query message 128, the communication database 28 may perform a database search 130 and determine the calling device 30 is pre-authorized to communicate with the managed device 34. The pre-authorized status of the calling device 30 may have been set during a previous communication session, and may apply to a specific type of communication, e.g., calls only, text only, calls and text permitted but not video, or all communication permitted. Based on the results of the database search 130, the communication database 28 may transmit a reply message 132 to the communication manager 26 including instructions or other data for processing the session request message 126. The communication manager 26 may process the session request 134 using the data received in the reply message 132 and determine that the calling device 30 is authorized to communicate with the managed device 34.

Based on the results of the processing 134, the communication manager 26 may transmit a session response message 136 to the mobile network 12 indicating the requested communication session is authorized. The mobile network 12 may then establish the communication session between the calling device 30 and managed device 34 by forwarding a session request message 138 to the managed device 34, which the user may accept 140, thereby triggering transmission of an acknowledgement message 142 to the mobile network 12. The mobile network 12 may then establish the communication session 144 between the calling device 30 and managed device 34.

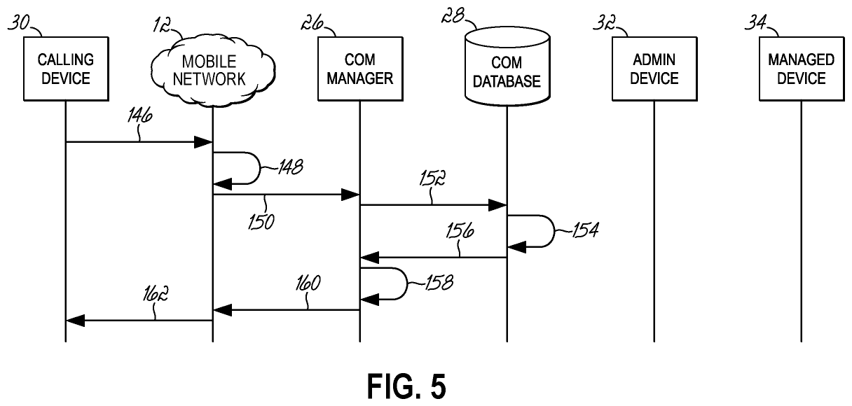

FIG. 5 depicts an exemplary scenario in which the calling device 30 attempts to initiate a communication session with the managed device 34 subsequent to having been denied authorization to communicate with the managed device 34, such as described above with respect to FIG. 3. The communication session may begin as described above with the calling device 30 transmitting a session request message 146 to the mobile network 12, the mobile network 12 processing the session request 148 and transmitting a session request message 150 to the communication manager 26, and the communication manager 26 transmitting a database query message 152 to the communication database 28.

In response to receiving the database query message 152, the communication database 28 may perform a database search 154 and determine the calling device 30 has been blacklisted with respect to the managed device 34. The blacklisted status of the calling device 30 may have been set during a previous communication session, and may only apply to one or more specific types of communication, e.g., video only, video and text only, all communication blacklisted, etc. Based on the results of the database search 154, the communication database 28 may transmit a reply message 156 to the communication manager 26. The communication manager 26 may process the session request 158 using the data received in the reply message 156 and determine that the calling device 30 is prohibited from communicating with the managed device 34.

Based on the results of the processing 158, the communication manager 26 may transmit a session response message 160 to the mobile network 12 indicating the requested communication session is denied. The mobile network 12 may then transmit a session termination message 162 that terminates the communication session with the calling device 30.

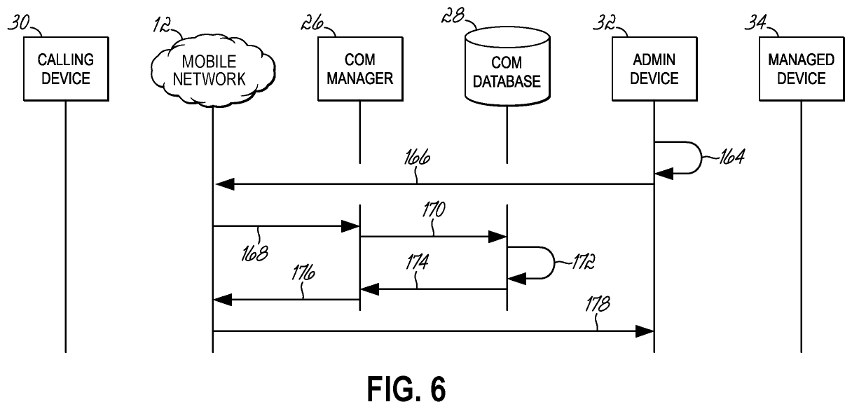

Referring now to FIG. 6, the communication management system 18 may be configured to allow the administrator to obtain reports on communication activities or update settings in the communication database 28 using the administrator device 32 or by logging into the communication manager 26 using some other computer running a suitable application, such as a desktop computer running a web browser.

By way of example, the administrator may provide an input 164 into the administrator device 32 indicating that the administrator wants to change a setting in the communication database 28 (e.g., add or remove the calling device 30 to or from a blacklist or whitelist) or retrieve information from the communication database 28 (e.g., how many communication sessions or attempted communication sessions have occurred between calling device 30 and managed device 34). In response to receiving the input 164, the administrator device 32 may transmit a request message 166 to the mobile network 12 requesting data from or an update to the communication database 28.

In response to receiving the request message 168 forwarded by the mobile network 12, the communication manager 26 may transmit a database query or update request message 170 to the communication database 28. The communication database 28 may then process the query/update 172 by updating the database or retrieving the requested data, and transmit a response message 174 to the communication manager 26. The communication manager 26 may then transmit a response message 176 to the mobile network 12 that is forwarded as response message 178 to the administrator device 32 to confirm the update or provide the requested data.

Although the above communication between the administrator device 32 and communication manager 26 is shown as being through the mobile network 12, embodiments of the invention are not so limited. Thus, it should be understood that the administrator device 32 may also communicate with the communication manager 26 directly. For example, a client application running on the administrator device 32 (e.g., a web browser) may establish communication with a server application running on the communication manager 26 (e.g., a web server) using the public network 22.

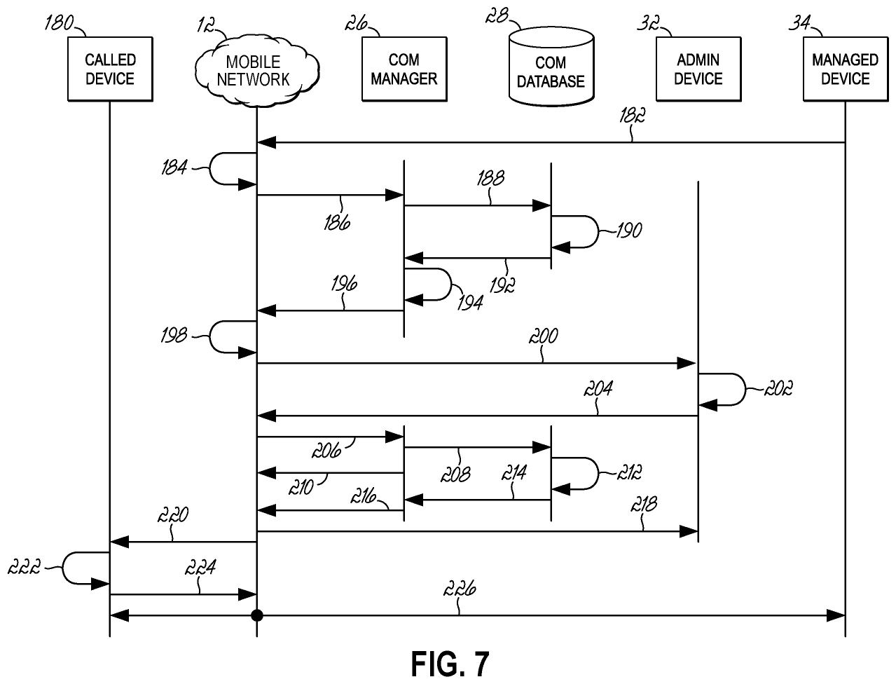

FIG. 7 depicts an exemplary scenario in which the managed device 34 initiates a communication session with a previously unknown called device 180, and the communication session is authorized by the administrator. To initiate the communication session, the managed device 34 may transmit a session request message 182 to the mobile network 12. The session request message 182 may include information that identifies the managed device 34, the called device 180, and the type of communication session being requested.

In response to receiving the session request message 182, the mobile network 12 may process the request 184, e.g., by performing a database query that requests routing information. The database query may return routing data indicating communication sessions originating from the managed device 34 are managed by the communication manager 26.

In response to determining that the communication session is managed by the communication manager 26, the mobile network 12 may transmit a session request message 186 to the communication manager 26. In response to receiving the session request message 186. The communication manager 26 may transmit a database query message 188 to the communication database 28 requesting information relating to how the session request message 40 should be processed.

In response to receiving the database query message 188, the communication database 28 may perform a database search 190 to determine if the managed device 34 is authorized to communicate with the called device 180, and if so, what rules apply to communication sessions between the managed device 34 and called device 180. If the called device 180 is not recognized by the communication database 28, the communication database 28 may determine what session processing rules to apply when the managed device 34 attempts to communicate with an unknown called device. In an embodiment of the invention, the results of the database search 190 may indicate that the called device 180 has been preemptively blocked by the administrator. In this case, the session processing rules may indicate that the session request message 182 should be denied even though the called device 180 has not previously been called by the managed device 34.

Based on the results of the database search 190, the communication database 28 may transmit a reply message 192 to the communication manager 26 including instructions or other data for processing the session request message 186. The communication manager 26 may process the session request 194 using the data received in the reply message 192. Depending on how the administrator has set up session processing rules for outbound communication from the managed device 34, the communication manager 26 may determine that the session request must be authorized by the administrator device 32 before the requested communication session can be established.

The authorization process may include the communication manager 26 transmitting an authorization request message 196 to the mobile network 12, and the mobile network 12 processing 198 and forwarding 200 the authorization request message to the administrator device 32. The administrator device 32 may process the authorization request message 202 by prompting the administrator to approve or deny the communication session, and transmit a reply message 204 to the mobile network 12. The mobile network 12 may forward the reply message 206 to the communication manager 26, and the communication manager 26 may transmit a database update message 208 to the communication database 28 and a session response message 210 to the mobile network 12.

The communication database 28 may update the database 212 in accordance with the contents of the database update message 208, e.g., by adding the called device 180 to a whitelist or a blacklist, and transmit an acknowledgement message 214 to the communication manager 26. The communication manager 26 may forward the acknowledgment message 216 to the mobile network 12, which in turn may forward the acknowledgement message 218 to the administrator device 32.

In response to receiving the session response message 210 indicating the requested communication session has been authorized, the mobile network 12 may attempt to establish the communication session by forwarding a session request 220 to the called device 180. If the user of the called device 180 accepts the request 222, the called device 180 may transmit an acknowledgement message 224 to the mobile network 12, which may in turn establish the communication session 226 between the managed device 34 and called device 180.

Although the above scenario is described with reference to called device 180, it should be understood that the “called device” may include any device or system with which the managed device 34 could communicate, such as a web server or other network node. Thus, the communication management system 18 may be used to control requests for communication sessions other than those involving calls or messages between mobile devices, such as a Hypertext Transfer Protocol (HTTP) request to connect to a URL using a web browsing application.

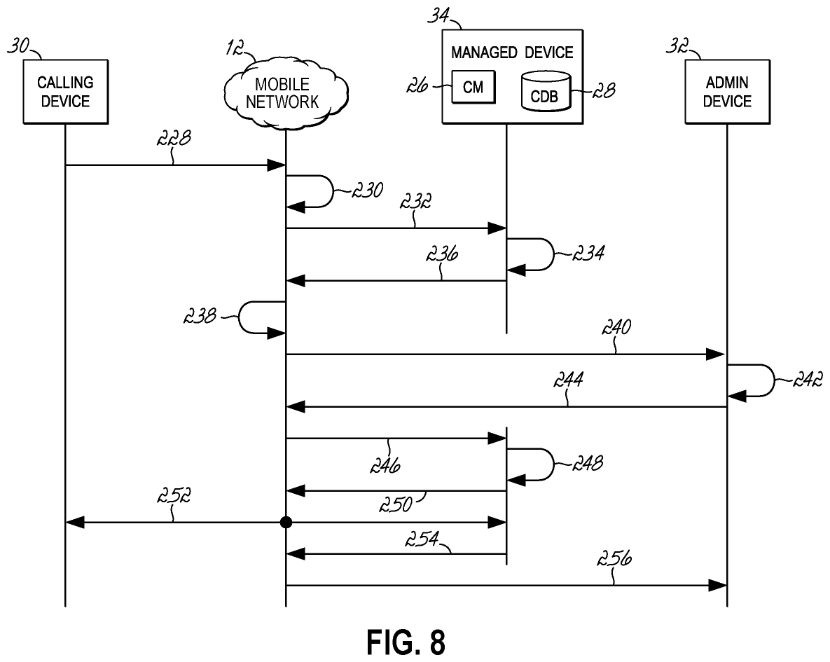

FIG. 8 depicts an embodiment of the invention in which at least a portion of the communication management system 18 resides on the managed device 34, an unknown calling device 30 attempts to initiate a communication session with the managed device 34, and the communication session is authorized by the administrator.

To initiate the communication session, the calling device 30 may transmit a session request message 228 to the mobile network 12. In response to receiving the session request message 228, the mobile network 12 may process the request 230 and forward the session request message 232 to the managed device 34.

In response to receiving the session request message 232, a running instance of the communication manager 26 on the managed device 34 may process the request 234 by performing a database query to the communication database 28. The communication database 28, or a portion thereof, may be stored locally on the managed device 34 as shown, or the communication manager 26 may access an external communication database 28, e.g., through the mobile or public network. The communication database 28 may perform a database search to determine if the calling device 30 is authorized to communicate with the managed device 34, and if so, what session processing rules apply to the calling device 30. Based on the results of the database search, the communication manager 26 may determine that the session request must be authorized using the administrator device 32 before the requested communication session can be established, and transmit an authorization request message 236 (e.g., in the form of a text message) to the mobile network 12 for delivery to the administrator device 32.

The mobile network 12 may process the authorization request message 238 and forward the authorization request message 240 to the administrator device 32, which may then process the authorization request 242. In response to receiving user input indicating the communication session is authorized, the administrator device 32 may transmit a reply message 244 to the mobile network 12, e.g., in the form of another text message. The mobile network 12 may in turn forward the reply message 246 to the managed device 34.

Based on the content of the reply message 246, the communication manager 26 may update the communication database 28 to reflect the authorization status of the calling device 30. Assuming the administrator has approved communication with the calling device 30, the communication manager 26 may also allow the managed device 34 to provide an indication to the user that a communication session has been requested by the calling device 30, e.g., by ringing or displaying calling party information to the user. In response to the user accepting the communication session 248, the managed device 34 may transmit an acknowledgement message 250 to the mobile network 12, which may in turn establish the communication session 252 between the calling device 30 and managed device 34.

The communication manager 26 may also transmit an acknowledgement message 254 indicating that the communication database 28 has been updated to the mobile network 12, which in turn may forward the acknowledgement message 256 to the administrator device 32. The administrator device 32 may provide an indication to the administrator that the status of the calling device 30 has been updated in the communication database 28.

To begin using the communication management system 18, a user wishing to be an administrator (e.g., the owner of the communication devices 14-16) may log into the communication management system 18 (e.g., using a web-browser) and create a communication management account. The administrator may then identify an application or communication device where authorization request messages should be routed, and enter numbers of the communication devices that are to be used by their dependents. Once the account is operational, the administrator may log into the account, add or delete administrator devices to be contacted for authorization, add or delete dependent communication devices, download communication manager applications, edit rules, and view the activities of dependent communication devices logged by the communication database 28.

Communication devices of dependents may need to be configured to receive calls after they are validated by the communication management system 18. This additional configuration may include adding additional computer code to the communication device (e.g., by downloading the communication manager application) that generates appropriate signals to either accept or disconnect/refuse an inbound or outbound communication request.

The administrator may initiate control over communication to managed devices by creating an account and purchasing a new mobile phone or a SIM card including an IMSI to install in an existing communication device. The administrator may also purchase a communication device with a custom operating system, or install a communication manager application an existing phone. In cases where an application is downloaded into the communication device, the application may need to be installed in the communication device and connected to the administrator's account.

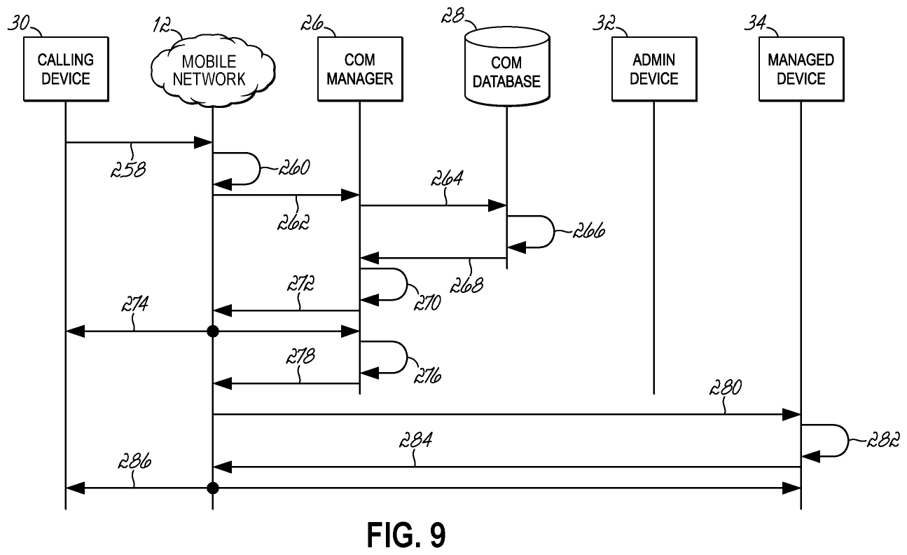

Referring now to FIG. 9, in an embodiment of the invention, the communication management system 18 may include a feature that enables an authorized user (e.g., a guardian or administrator) using an unknown calling device 30 to bypass the normal authentication process. This feature may allow the authorized user to reach the managed device 34 in the event they are using an unknown phone to make the call, e.g., because they left their phone at home and are using borrowed phone.

The communication session may begin with the calling device 30 transmitting a session request message 258 to the mobile network 12. In response, the mobile network 12 may process the request 260 and determine that the managed device 34 is subscribed to the communication management feature associated with the communication manager 26, and transmit a session request message 262 to the communication manager 26. In response to receiving the session request message 262, the communication manager 26 may transmit a database query message 264 to the communication database 28 requesting information relating to how the session request message 86 should be processed.

In response to receiving the database query message 264, the communication database 28 may perform a database search 266 and, because the calling device 30 is unknown, return session processing rules that require authorization. The communication database 28 may then transmit a reply message 268 to the communication manager 26 including the session processing rules. The communication manager 26 may process the session request 270 using data received in the reply message 268, and determine that a communication session should be established between the calling device 30 and the communication manager 26 before the requested communication session can be established. The communication manager 26 may then transmit a session request message 272 to the mobile network 12. In response to receiving the message 272, the mobile network 12 may establish a communication session 274 between the communication manager 26 and calling device 30, e.g., a voice channel or sequence of text messages.

During the communication session, the authorized user may provide a passcode to the communication manager 26, e.g., by entering the passcode through a user interface or speaking into the calling device 30. In response to receiving the passcode, the communication manager 26 may process the passcode 276, and if the passcode is authentic, transmit a session setup message 278 to the mobile network 12. The mobile network 12 may then establish the communication session between the calling device 30 and managed device 34 by forwarding a session request message 280 to the managed device 34, which the user may accept 282, thereby triggering transmission of an acknowledgement message 284 to the mobile network 12. The mobile network 12 may then establish the communication session 286 between the calling device 30 and managed device 34.

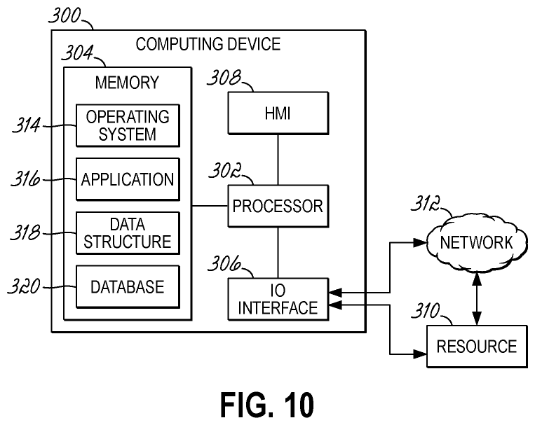

Referring now to FIG. 10, embodiments of the invention described above, or portions thereof, may be implemented using one or more computer devices or systems, such as exemplary computer 300. The computer 300 may include a processor 302, a memory 304, an input/output (I/O) interface 306, and a Human Machine Interface (HMI) 308. The computer 300 may also be operatively coupled to one or more external resources 310 via a network 312 or the I/O interface 306. External resources may include, but are not limited to, servers, databases, mass storage devices, peripheral devices, cloud-based network services, or any other resource that may be used by the computer 300.

The processor 302 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in memory 304. Memory 304 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or data storage devices such as a hard drive, optical drive, tape drive, volatile or non-volatile solid state device, or any other device capable of storing data.

The processor 302 may operate under the control of an operating system 314 that resides in memory 304. The operating system 314 may manage computer resources so that computer program code embodied as one or more computer software applications, such as an application 316 residing in memory 304, may have instructions executed by the processor 302. In an alternative embodiment, the processor 302 may execute the application 316 directly, in which case the operating system 314 may be omitted. One or more data structures 318 may also reside in memory 304, and may be used by the processor 302, operating system 314, or application 316 to store or manipulate data.

The I/O interface 306 may provide a machine interface that operatively couples the processor 302 to other devices and systems, such as the external resource 310 or the network 312. The application 316 may thereby work cooperatively with the external resource 310 or network 312 by communicating via the I/O interface 306 to provide the various features, functions, applications, processes, or modules comprising embodiments of the invention. The application 316 may also have program code that is executed by one or more external resources 310, or otherwise rely on functions or signals provided by other system or network components external to the computer 300. Indeed, given the nearly endless hardware and software configurations possible, persons having ordinary skill in the art will understand that embodiments of the invention may include applications that are located externally to the computer 300, distributed among multiple computers or other external resources 310, or provided by computing resources (hardware and software) that are provided as a service over the network 312, such as a cloud computing service.

The HMI 308 may be operatively coupled to the processor 302 of computer 300 to allow a user to interact directly with the computer 300. The HMI 308 may include video or alphanumeric displays, a touch screen, a speaker, and any other suitable audio and visual indicators capable of providing data to the user. The HMI 308 may also include input devices and controls such as an alphanumeric keyboard, a pointing device, keypads, pushbuttons, control knobs, microphones, etc., capable of accepting commands or input from the user and transmitting the entered input to the processor 302.

A database 320 may reside in memory 304, and may be used to collect and organize data used by the various systems and modules described herein. The database 320 may include data and supporting data structures that store and organize the data. In particular, the database 320 may be arranged with any database organization or structure including, but not limited to, a relational database, a hierarchical database, a network database, or combinations thereof. A database management system in the form of a computer software application executing as instructions on the processor 302 may be used to access the information or data stored in records of the database 320 in response to a query, which may be dynamically determined and executed by the operating system 314, other applications 316, or one or more modules.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations or elements embodying the various aspects of the embodiments of the invention. Computer-readable program instructions for carrying out operations of the embodiments of the invention may be, for example, assembly language, source code, or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a computer program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, or operations specified in the flow-charts, sequence diagrams, or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, or operations specified in the flow-charts, sequence diagrams, or block diagrams.

In certain alternative embodiments, the functions, acts, or operations specified in the flow-charts, sequence diagrams, or block diagrams may be re-ordered, processed serially, or processed concurrently consistent with embodiments of the invention. Moreover, any of the flow-charts, sequence diagrams, or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include both the singular and plural forms, and the term “or” is intended to include both alternative and conjunctive combinations, unless the context clearly indicates otherwise. It will be further understood that the terms “comprises” or “comprising,” when used in this specification, specify the presence of stated features, integers, actions, steps, operations, elements, or components, but do not preclude the presence or addition of one or more other features, integers, actions, steps, operations, elements, components, or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A system comprising:
one or more processors; and
a memory coupled to the one or more processors and including program code that, when executed by the one or more processors, causes the system to:
receive a request to initiate a communication session between a first communication device and a second communication device;
query a communication database for a rule governing the communication session between the first communication device and the second communication device; and
process the request in accordance with the rule, wherein the rule requires one of forwarding the request to an administrator device, forwarding the request to one of the first communication device or the second communication device, or denying the request.

2. The system of claim 1 wherein the request is forwarded to the administrator device, and the program code further causes the system to:
cause first data to be displayed on the administrator device identifying the at least one of the first communication device or the second communication device; and
receive, from the administrator device, second data indicating whether to forward the request or deny the request.

3. The system of claim 2, wherein the program code further causes the system to:
in response to the second data indicating the request is to be forwarded to the one of the first communication device and the second communication device, update the rule governing the communication session between the first communication device and the second communication device so that a subsequent request for the communication session is forwarded to the one of the first communication device or the second communication device; and
in response to the second data indicating the request is to be denied, update the rule governing the communication session between the first communication device and the second communication device so that the subsequent request for the communication session is denied.

4. The system of claim 2 wherein the first communication device is one of a calling device or a called device, and the second communication device is the other of the calling device and the called device.

5. The system of claim 2 wherein the communication manager resides on the first communication device or the second communication device.

6. The system of claim 2 wherein the communication session is a voice call, a text message, a video call, or a Hypertext Transfer Protocol session.

7. The system of claim 1 wherein forwarding the request to the administrator device comprises sending a text message to the administrator device containing first data identifying at least one of the first communication device or the second communication device.

8. The system of claim 1 wherein forwarding the request to the one of the first communication device or the second communication device comprises transmitting one or more messages that establish the communication session between the first communication device and the second communication device in a mobile network.

9. The system of claim 1 wherein denying the request comprises causing a mobile network to terminate the communication session.

10. A method comprising:
receiving, by a communication manager, a request to initiate a communication session between a first communication device and a second communication device;
querying, by the communication manager, a communication database for a rule governing the communication session between the first communication device and the second communication device; and
processing, by the communication manager, the request in accordance with the rule, wherein the rule requires one of forwarding the request to an administrator device, forwarding the request to one of the first communication device or the second communication device, or denying the request.

11. The method of claim 10 wherein the processing of the request forwards the request to the administrator device, and further comprising:
displaying, by the administrator device, first data identifying at least one of the first communication device or the second communication device;
receiving, by the administrator device, input indicating whether the request to initiate the communication session is authorized; and
transmitting, by the administrator device to the communication manager, second data indicating whether to forward the request or deny the request.

12. The method of claim 11, further comprising:
in response to the second data indicating the request is to be forwarded to the one of the first communication device and the second communication device, updating the rule governing the communication session between the first communication device and the second communication device so that a subsequent request for the communication session is forwarded to the one of the first communication device or the second communication device; and
in response to the second data indicating the request is to be denied, updating the rule governing the communication session between the first communication device and the second communication device so that the subsequent request for the communication session is denied.

13. The method of claim 11 wherein the first communication device is one of a calling device or a called device, and the second communication device is the other of the calling device and the called device.

14. The method of claim 11 wherein the communication manager resides on one of the first communication device or the second communication device.

15. The method of claim 11 wherein the communication session is a voice call, a text message, a video call, or a Hypertext Transfer Protocol session.

16. The method of claim 15 wherein the communication session is the Hypertext Transfer Protocol session with a social-media website.

17. The method of claim 10 wherein forwarding the request to the administrator device comprises sending a text message to the administrator device containing first data identifying at least one of the first communication device or the second communication device.

18. The method of claim 10 wherein forwarding the request to the one of the first communication device or the second communication device comprises transmitting one or more messages that establish the communication session between the first communication device and the second communication device in a mobile network.

19. The method of claim 10 wherein denying the request comprises causing a mobile network to terminate the communication session.

20. A computer program product comprising:
a non-transitory computer-readable storage medium; and
program code stored on the non-transitory computer-readable storage medium that, when executed by one or more processors, causes the one or more processors to:
receive a request to initiate a communication session between a first communication device and a second communication device;
query a communication database for a rule governing the communication session between the first communication device and the second communication device; and
process the request in accordance with the rule, wherein the rule requires one of forwarding the request to an administrator device, forwarding the request to the one of the first communication device or the second communication device, or denying the request.
